(19) United States
(12) Patent Application Publication
(10) Pub. No.: US 2025/0259101 A1
(43) Pub. Date: Aug. 14, 2025

(54) SYSTEM AND METHODS TO RECOMMEND ITEMS THAT INCREASE LONG-TERM USER SATISFACTION

(71) Applicant: Pinterest, Inc., San Francisco, CA (US)

(72) Inventors: Mehdi Ben Ayed, Jersey City, NJ (US); Vishwakarma Singh, Sunnyvale, CA (US)

(73) Assignee: Pinterest, Inc., San Francisco, CA (US)

(21) Appl. No.: 18/913,860

(22) Filed: Oct. 11, 2024

Related U.S. Application Data
(60) Provisional application No. 63/551,506, filed on Feb. 8, 2024.

(51) Int. Cl. G06F 16/9535

(52) U.S. Cl. CPC G06N 20/00; G06F 16/9535

(57) ABSTRACT

Described are systems and methods that resolve the shortcomings of existing recommendation systems that focus on immediate user reward rather than long-term user satisfaction. The disclosed implementations increase user session duration and user session depth during a session by selecting items that incent the user to remain engaged and participating in the session, rather than optimizing for immediate user metrics.

### CROSS REFERENCE TO PRIOR APPLICATIONS

This application claims priority to and the benefit of U.S. Provisional Patent Application No. 63/551,506, filed on Feb. 8, 2024, which is hereby incorporated by reference in its entirety.

### BACKGROUND

Existing web-scale recommendation systems serve billions of items to millions of users and are commonly built using supervised learning methods. While such methods may be good for determining the best immediate result, these methods fail to capture long-term user satisfaction due to their heavy reliance on immediate user feedback.

### BRIEF DESCRIPTION OF THE DRAWINGS

FIGS. 1A and 1B are illustrations of an exemplary computing environment, in accordance with implementations of the present disclosure.

FIG. 2 is a block diagram illustrating additional details of the example distributed training system illustrated in FIG. 1, in accordance with implementations of the present disclosure.

FIG. 3 is a block diagram illustrating additional example components of the data generator and the agent trainer, in accordance with implementations of the present disclosure.

FIG. 4 is an example data generation process, in accordance with implementations of the present disclosure.

FIG. 5 is an example illustration of a simulator architecture, in accordance with implementations of the present disclosure.

FIG. 6 is a flow diagram of an exemplary training process for training a simulator model, in accordance with implementations of the present disclosure.

FIG. 7 is an example illustration of an architecture that may be utilized in item selection directed toward increasing a user episode duration, in accordance with implementations of the present disclosure.

FIG. 8 is a flow diagram of an exemplary agent trainer policy update process, in accordance with implementations of the present disclosure.

FIG. 9 is a block diagram of an exemplary computing resource, in accordance with implementations of the present disclosure.

### DETAILED DESCRIPTION

Recommendation systems continue to become increasingly prevalent in our digital world. However, existing systems only consider immediate user feedback and fail to identify or recommend items that increase a user's long-term satisfaction. For example, existing systems may be good at providing a response that satisfies the user's immediate desire, but that same item may do nothing (or little) to keep the user engaged in a session and/or continue a session. Currently, in many instances, once the user has satisfied that immediate need, the user may terminate their session. As a result, such existing systems cause a decrease in user satisfaction over time.

While reinforcement learning (“RL”) is an improvement for maximizing long-term goals, applying RL at scale, such as in a web-scale enterprise recommendation system, is challenging due to the extremely large action space of such systems. For example, with such a large action space (millions or billions of possible results), the number of items that an RL system may determine is very large such that the dimensionality of RL does not scale.

The underlying mathematical formulation of RL is a Markov Decision Process (“MDP”) which assumes that the correlation between consecutive observations can be depicted by a transition kernel determined by the executed action. The objective of MDPs is to learn a policy (i.e., a mapping from observations to actions) such that the cumulative rewards collected along the sequence are maximized. In many instances, existing attempts at using RL for large scale recommendations have resulted in the RL system learning what the user does not like because the vast majority of the large scale action space includes items in which the user is not interested.

As discussed further below, the disclosed implementations resolve these shortcomings of existing web-scale recommendation systems, resolve the problems of using RL at scale, and provide a recommendation system directed toward increasing long-term user satisfaction. Long-term user satisfaction, as used herein, means a longer session duration of a user session, an increased number of item views or activities (share, long click, search, etc.) by the user during a user session, and/or an increased number of user sessions by the user over a period of time. The disclosed implementations utilize multiple techniques to address training difficulties, such as using supervised learning to warm-start an agent model, define and utilize a training pipeline to reach web-scale level of functionality, and utilize an exploration strategy that prioritizes high-value actions. The disclosed implementations increase user session duration and user session depth during a session by selecting items that incent the user to remain engaged and participating in the session, rather than directed toward immediate user metrics.

As discussed further below, a data generator and a RL trainer, also referred to herein as an agent trainer, may be utilized as a distributed training system. A “data generator,” as used herein, refers to a component(s) of the disclosed implementations that generates simulated episodes of actions (selection of candidate items) and corresponding feedback, which may be represented as a reward or reward value. The data generator, following a policy, selects an item and a simulator of the data generator simulates a user feedback (short watch, long watch, share, click, search, exit, etc.) in response to the item. The selection of an item by the data generator is referred to herein as an “action” and the simulated user behavior (short watch, long watch, share, click, search, exit, etc.) is referred to herein as a feedback, which may be represented as a reward or reward value. With each action-feedback pair, an episode step of the episode is updated, and another action and feedback simulated. As discussed further below, this process by the data generator may continue until the simulated feedback is an end episode (e.g., exit).

The data generator operates asynchronously from other system components, in some implementations, utilizing multiple parallel data generator worker components to efficiently generate diverse simulated episodes, which may then be used as training data. The simulated episodes/training data may then be stored in a replay buffer. A “data generator worker component” or “data generator worker,” as used herein, refers to a component of the data generator. Each data generator worker operates independently and in parallel with other data generator workers to produce simulated episodes that may include many episode steps of actions and rewards, also referred to herein as transitions. Each data generator worker uses the exploration policy, discussed below, and a simulator of the data generator to generate episode steps of the episode, which are written to the replay buffer. Data generator workers enable efficient, parallel creation of diverse training data.

An “RL trainer” or “agent trainer,” as used herein, refers to a component(s) of the disclosed implementations that updates and optimizes a policy directed toward increasing long-term user satisfaction. The agent trainer operates asynchronously from the data generator, retrieving the simulated episodes and/or episode steps of the episodes generated by the data generator and stored in the replay buffer. As discussed further below, the agent trainer uses the retrieved simulated episode steps and/or episodes, also referred to herein as a batch of retrieved simulated episode steps or a batch of retrieved simulated episodes, to perform gradient-based optimization, updating the policy to direct the policy toward increasing long-term user satisfaction. In some implementations, the agent trainer includes multiple agent worker components coordinated by an agent manager. The agent manager assigns one or more simulated episode steps and/or one or more simulated episodes retrieved from the replay buffer to each of the agent trainer workers for parallel processing and computation of stochastic gradients or estimates of the true gradient based on the sub-set of data provided to each agent trainer worker. The agent manager aggregates the computed gradients and uses the aggregate gradient to update the policy to direct the policy toward increasing long-term user satisfaction.

As the policy is updated, the policy may be periodically provided to a production environment as a recommendation policy to guide real-time item recommendations that are presented to users of the production environment. Likewise, the policy may be provided back to the data generator as an exploration policy that guides the selection of items (actions) for episode simulations.

A “recommendation policy,” “exploration policy,” or “policy,” as used herein and as mentioned above, refers to a policy, which may be a strategy or set of rules that guide a recommendation system, such as a trained neural network, in generating actions (selecting items), that are used in simulations (by the data generator) and/or presented to users (by a recommendation system). As discussed below, the policy may be used to train or refine a machine learning model, such as a neural network, to implement the policy when selecting items that are presented to a user and/or to select items as part of a simulation.

As discussed further below, within each of the data generator and the RL trainer, multiple worker components may be established to share processing of the respective tasks. Such an infrastructure significantly enhances the training efficiency necessary for a system to operate at scale where speed is critical, as it allows for rapid and ongoing training that keeps pace with changes in the real-world environment, such as the constant influx of new items being added to a corpus of items, user preferences changing, etc.

Additionally, in some implementations, to reduce exploration difficulty arising from sparse rewards, the disclosed implementations may utilize feedback reward values that exist between a range of real numbers, such as between 0-1 real numbers, rather than event indicators, which are binary 0 or 1, for reward computation. The use of feedback reward values that exist between a range of real numbers improves the stability of learning. Likewise, because of the extremely large corpus of data, in some implementations, a hybrid prioritized exploration strategy may be utilized, which combines a greedy strategy with a SoftMax® strategy, with a priority truncation on the action set. Such an approach improves naive exploration while fitting within practical constraints.

Still further, to utilize a supervised production predictive model, which gives predictions of user feedback given a recommended item (action), the traditional feature engineering, model architecture, and network weights for such a system are modified in the disclosed implementations to warm-start a simulator and agent model(s). The production predictive model may thus be tuned based on real-world feedback for a long period. Transfer learning from such a mature system improves state and action representations and learning efficiency, which is necessary for scaling to massive state and action spaces, such as a web-scale corpus of data with millions or billions of items.

To aid in explanation of the disclosed implementations, the examples discussed herein focus primarily on the recommendation of videos, such as feed streaming recommendations of videos. However, it will be appreciated that the disclosed implementations are equally applicable to any of a variety of forms of digital items and may include recommending many different types of digital items (e.g., audio, video, images) separately or collectively.

In the context of web-scale recommender systems, such as feed streaming platforms, interactions occur between a recommendation system of the disclosed implementations and a user u∈ [symbol] . At each time step t, the recommendation system presents the user with a specific item aₜ from a set [symbol] of candidates based on a user context of the user. The user may then provide explicit feedback [symbol] ₜ, which may include responses such as “partial watch,” “long watch,” “save,” “hide,” “share,” “exit,” etc. A partial watch may be defined as any watch of a data item (e.g., video) that is less than a specified amount (e.g., 75%, 80%, 90%) and a long watch may be defined as any watch of the data item that exceeds the specified amount. The feedback is used by the recommendation system to understand the user's preference. Formally, the MDP may be defined as:
S: the state at time t

$${s}_{t} := \{ u , ( {a}_{t - L} , {ℱ}_{t - L} ) , … , ( {a}_{t - 1} , {ℱ}_{t - 1} ) \} , \qquad ( 1 )$$

where u is the user embedding that encapsulates a user's interests and preferences and (a_{t-L}, [symbol] _{t-L}), . . . , (aₜ₋₁, [symbol] ₜ₋₁) contains the most recent L recommended items together with the user's feedback.
[symbol] : a set of recommendable items
R: A numerical reward value, determined by various types of user feedback.

As discussed further below, the disclosed implementations focus on improving the overall quality of all recommended items (e.g., videos) to increase session duration or depth for a user. The disclosed implementations utilize a transformer-based deep reinforcement learning architecture to learn users' long-term satisfaction and scale both the training and the service to power a large recommendation system with millions or billions of recommendable items and millions or billions of users.

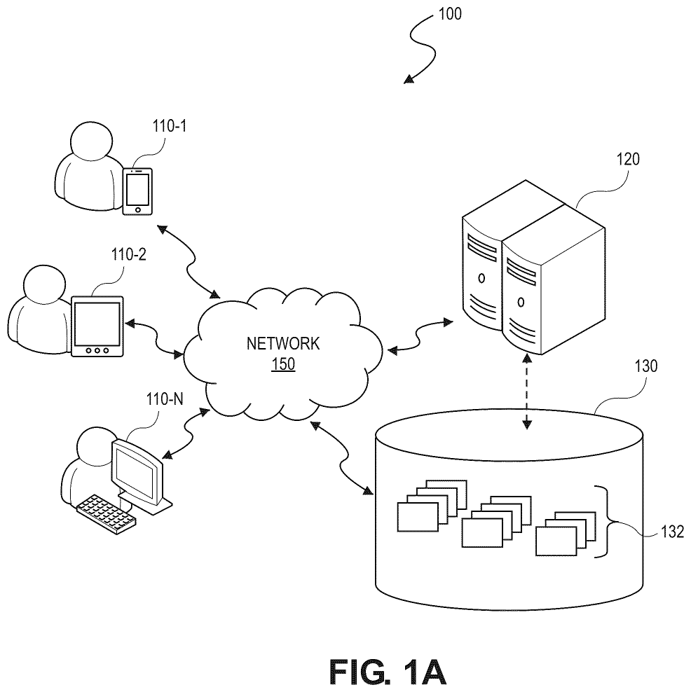

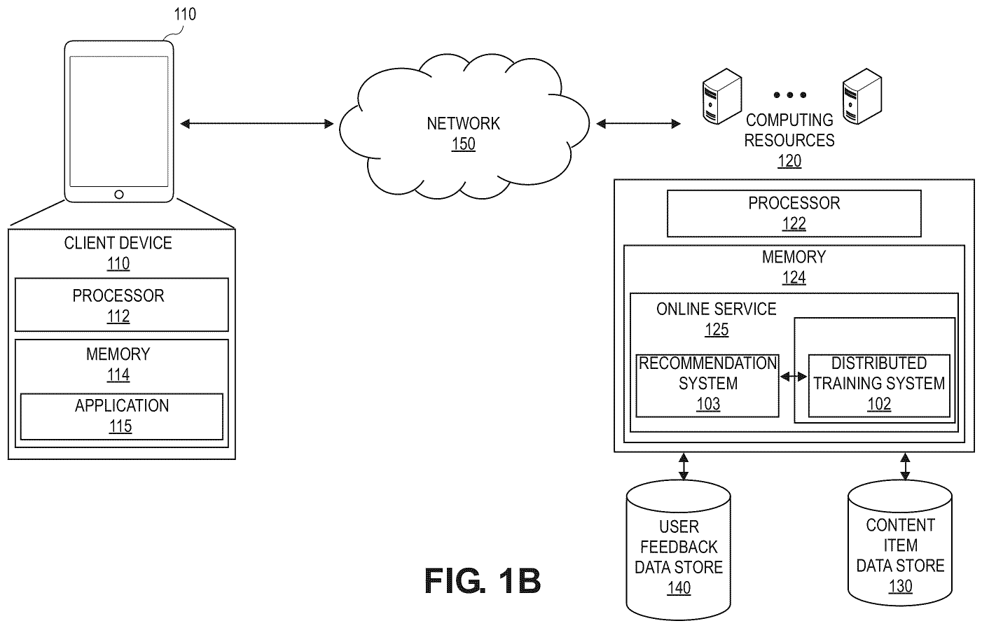

FIGS. 1A and 1B are illustrations of an exemplary computing environment 100, according to implementations of the present disclosure.

As shown in FIG. 1A, computing environment 100 may include one or more client devices 110 (e.g., client device 110-1, 110-2, through 110-N), also referred to as user devices, for connecting over a network 150 to access computing resources 120. Client devices 110 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110 and computing resources 120. Computing resources 120 may represent at least a portion of a networked computing system that may be configured to provide online applications, services, computing platforms, servers, and the like, such as a social networking service, social media platform, e-commerce platform, content recommendation services, search services, and the like, that may be configured to execute on a networked computing system. Further, computing resources 120 may communicate with one or more data store(s) 130, which may be configured to store and maintain content items 132, also referred to herein generally as items. Content items 132 may include any type of digital content, such as digital images, videos, documents, and the like.

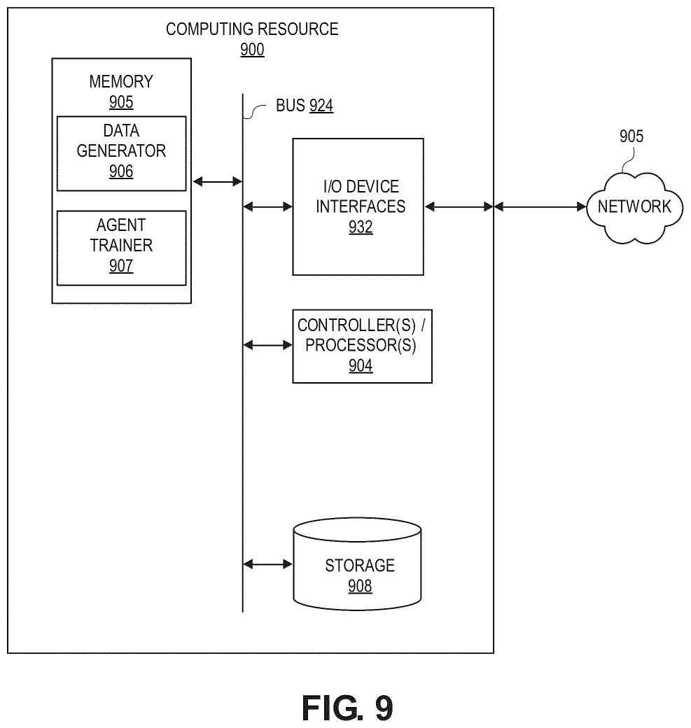

According to exemplary implementations of the present disclosure, computing resources 120 may be representative of computing resources that may form a portion of a larger networked computing platform (e.g., a cloud computing platform, and the like), which may be accessed by client devices 110. Computing resources 120 may provide various services and/or resources and do not require end-user knowledge of the physical premises and configuration of the system that delivers the services. For example, computing resources 120 may include “on-demand computing platforms,” “software as a service (Saas),” “infrastructure as a service (IaaS),” “platform as a service (PaaS),” “platform computing,” “network-accessible platforms,” “data centers,” “virtual computing platforms,” and so forth. As shown in FIG. 1A, computing resources 120 may be configured to execute and/or provide a social media platform, a social networking service, a recommendation service, a search service, and the like. Example components of a remote computing resource, which may be used to implement computing resources 120, is discussed below with respect to FIG. 9.

As illustrated in FIG. 1A, one or more of client devices 110 may access computing resources 120, via network 150, to access and/or execute applications and/or content in connection with a social media platform, a social networking service, a recommendation service, a search service, and the like. According to implementations of the present disclosure, client devices 110 may access and/or interact with one or more services executing on remote computing resources 120 through network 150, via one or more applications operating and/or executing on client devices 110. For example, users associated with client devices 110 may launch and/or execute such an application on client devices 110 to access and/or interact with services executing on remote computing resources 120 through network 150. According to aspects of the present disclosure, a user may, via execution of the application on client devices 110, access or log into services executing on remote computing resources 120 by submitting one or more credentials (e.g., username/password, biometrics, secure token, etc.) through a user interface presented on client devices 110.

Once logged into services executing on remote computing resources 120, the user associated with one of client devices 110 may submit a request for content items, submit searches and/or queries, and/or otherwise consume content items hosted and maintained by services executing on remote computing resources 120. For example, the request for content items may be included in a query (e.g., a text-based query, an image query, etc.), a request to access a homepage and/or home feed, a request for recommended content items, and the like. Alternatively and/or in addition, services executing on remote computing resources 120 may push content items to client devices 110. For example, services executing on remote computing resources 120 may push content items 132 to client devices 110 on a periodic basis, after a certain period of time has elapsed, as part of an ongoing feed of content items, based on activity associated with client devices 110, upon identification of relevant and/or recommended content items that may be provided to client devices 110, and the like.

Accordingly, services executing on remote computing resources 120 may employ one or more trained machine learning models to determine and identify content items (e.g., from content items 132) that are relevant to the request for content items. The content items may be determined and identified from the content items 132. The request for content items can be, for example, as part of a query, request to access a homepage and/or home feed, a request for recommended content, or any other request for content items. The determined content items may then be pushed to or otherwise presented on a client device 110. In exemplary implementations, the one or more trained machine learning models may utilize a recommendation policy that is generated and provided by a distributed training system that utilizes one or more data generators and one or more agent trainers to generate and periodically update the recommendation policy, as discussed herein. The trained machine learning model, utilizing the recommendation policy, may recommend items that are selected to increase long-term user behavior, such as extended user episode duration/depth.

In accordance with the disclosed implementations, the distributed training system, as part of generating or updating the policy, may be configured to simulate one or more episodes, each episode including one or more episode steps. At each episode step, based on knowledge of a user at a current user state, the data generator of the distributed training system determines an action (selection of an item) and the simulator simulates a feedback in response to the action, assigns a reward value based on the feedback, determines a new state of the user, and completes the transition. This sequence may continue for one or more episode steps until the feedback is an end episode, at which time the episode is considered complete. The simulated episode(s), as discussed further below, may be used by the agent trainer of the distributed training system to update a policy to direct the policy toward a goal of extending user session duration/depth (increasing long-term user satisfaction). The policy may then be deployed/published to a production environment as a recommendation policy for use by a machine learning model, such as a recommendation system, in selecting items to present to users, such that the selected and presented items are chosen with a goal of increasing long-term user satisfaction.

For example, the data generator may simulate multiple episodes, each episode including one or more episode steps. Each episode step includes an action (selection of an item) and a simulated feedback (“partial watch,” “long watch,” “save,” “hide,” “share,” “exit,” etc.) indicating simulated behavior in response to presentation of the action (selected item). As described herein, each feedback may be assigned a reward value. A predicted items value may be assigned to the episodes based on the number of actions (selection of items) of the episodes that are selected and presented before the simulated reward is an exit (e.g., ending the episode) and/or based on the reward values attributed to the simulated feedbacks. For example, the predicted items value may be calculated based on the number of actions (selection and presentation of an items) during a simulated episode and the corresponding rewards, with more actions during the simulated episode resulting in a higher predicted items value. A long-term value may then be computed and assigned to each episode based on the predicted items value and the predicted reward values of that episode.

In exemplary implementations of the present disclosure, the distributed training system 102 executing on remote computing resources 120 may employ one or more trained machine learning models to implement certain conditional retrieval techniques to determine a next action (select item) of an episode to simulate for presentation to the simulated user. The conditional retrieval techniques may be learned as part of the one or more sequential trained machine learning models, or may include one or more additional trained machine learning models. The conditional retrieval techniques may determine context aware updated embeddings based on the embedding generated by the sequential trained machine learning model and certain contextual information. The contextual information can include, for example, a query submitted by the user, a user engagement (e.g., a content item with which the user has engaged, etc.), an interest associated with the user, and the like. The context aware updated embeddings may also be used in connection with identifying and/or determining actions to simulate as presented to the simulated user as part of an episode. According to certain aspects of the present disclosure, while the embedding generated by the sequential trained machine learning model may be determined offline, the context aware updated embeddings may be determined in real-time. For example, as contextual information (e.g., a received query, a recent engagement with a content item, updated simulated user engagement with content items as part of an episode, etc.) is received by the services executing on remote computing resources 120, the context aware updated embeddings may be determined in real-time or near real-time.

According to exemplary implementations of the present disclosure, the agent trainer may utilize or include services executing on remote computing resources 120 that implement a taxonomy and/or graph including a plurality of nodes. Each node is associated with one or more topics, interests, and the like, and content items (e.g., content items 132) are mapped to one or more nodes of the taxonomy, to facilitate provisioning of responsive content items (actions). According to aspects of the present disclosure, a taxonomy can include a hierarchical structure including one or more nodes for categorizing, classifying, and/or otherwise organizing objects (e.g., topics, interests, content items, etc.). Each of the one or more nodes can be defined by an associated category, classification, etc., such as an interest, topic, and the like. Accordingly, the taxonomy implemented by services executing on remote computing resources 120 can facilitate efficient identification, determination, and/or provisioning of content items that are relevant to a simulated request for content items. The simulated request for content items can be, for example, as part of a query, request to access a homepage and/or home feed, a request for recommended content, or any other request for content items. The action of determining content items may then be simulated as pushed to, or otherwise presented to a user based on the embeddings and/or the context aware updated embeddings generated by the trained machine learning model(s). The trained machine learning models may be, for example, sequential trained machine learning model(s), one or more trained machine learning models employing conditional retrieval techniques, etc.

In one implementation, a data generator worker of the data generator may generate multiple episode steps for each episode and generate multiple episodes. Each episode step includes a previous user state (at the beginning of the episode step), an action, a reward value indicative of a simulated feedback in response to the action, and an updated user state that factors in the action and reward value as if the action had been performed and the user provided the feedback. Each episode step may be stored in a replay buffer. As discussed below, in some implementations, multiple agent workers are generated to produce different simulated episodes. As discussed further below, each data generator worker, based on a user embedding and employing machine learning models, generates a first action (selects a first content item from a corpus of content items or from a set of content items determined to be of potentially a highest interest to the user). The simulator of the data generator worker then simulates a first feedback (a predicted user behavior in response to the item), assigns a first reward value based on the first feedback, updates the user state, and advances the simulated episode to a next episode step. Updating the user state of the user may include updating the user embedding based on the first action and the first reward, as if the first content item was presented to the user and the user behaved according to the simulated feedback. The data generator worker then utilizes the updated user embedding and machine learning techniques to generate a second action (second candidate item) and the simulator simulates a second feedback (second simulated user behavior in response to the item), assigns a second reward value, and again updates the user state and advances the episode to a next episode step. This process may continue, which includes an action (selection of a content item) and simulated feedback (simulated user behavior in response to the item), reward value, updating the user state, and advancing the episode step, until the simulated feedback is an exit, thereby ending the episode. As noted above, an action value may be determined for the episode based on the number of actions performed during the episode. Likewise, a reward value may be determined for the episode based on the feedback simulated during the episode and the corresponding assigned reward values. A long-term value for the episode, or action (candidate item) of the episode, may then be determined based on the action value of the episode and/or the reward value of the episode.

FIG. 1B is a block diagram of an exemplary computing environment, including client device 110 and computing resources 120 implementing an online service 125, according to exemplary implementations of the present disclosure. The exemplary system shown in FIG. 1B may facilitate implementation of a social media platform, a social networking service, a recommendation service, a search service, and the like.

As illustrated, client device 110 may be any portable device, such as a tablet, cellular phone, laptop, wearable, etc. Client device 110 may be connected to the network 150 and may include one or more processors 112 and one or more memory 114 or storage components (e.g., a database or another data store). Further, client device 110 may execute an application 115, which may be stored in memory 114 and by the one or more processors 112 of the client device 110 to cause the processor(s) 112 of client device 110 to perform various functions or actions. According to exemplary implementations of the present disclosure, the application 115 may execute on the client device 110 in connection with a social media platform, a social networking service, a recommendation service, a search service, and the like, which may be further implemented via online service 125, executing on computing resources 120. As illustrated, the computing resources 120 may include one or more processors 122 and a memory 124 storing program instructions, such as the recommendation system 103 and/or the distributed training system 102, among others. The program instructions, when executed by the one or more processors 122, perform one or more aspects of the implementation discussed herein. For example, when executed, application 115 may verify the identity of the user, connect to online service 125, submit request for content items, submit queries, and the like.

Application 115 executing on client device 110 may communicate, via network 150, with online service 125, which may be configured to execute on computing resources 120. Generally, online service 125 includes and/or executes on computing resource(s) 120. As discussed herein, the online service may include a recommendation system 103 that recommends content items based on a recommendation policy that is directed toward increasing long-term user satisfaction, in accordance with the disclosed implementations. Likewise, computing resource(s) 120 may be configured to communicate over network 150 with client device 110 and/or other external computing resources, data stores, such as content item data store 130, user feedback data store 140, and the like. As illustrated, computing resource(s) 120 may be remote from client device 110 and may, in some instances, form a portion of a network-accessible computing platform implemented as a computing infrastructure of processors, storage, software, data access, and so forth, via network 150, such as an intranet (e.g., local area network), the Internet, etc.

The computing resources may also include or connect to one or more data stores, such as content item data store 130, user feedback data store 140, and the like. Content item data store 130 may be configured to store and maintain a corpus of content items, including one or more content items (e.g., content items 132) and user feedback data store 140 may be configured to store and maintain user feedback from users (e.g., by users associated with client devices 110) in their engagement with online service 125. For example, the user feedback stored and maintained may include content (e.g., content items 132, etc.) accessed, interacted with, saved, shared, hidden, consumed, etc., by the user, searches performed by the user, content items added to online service 125, and the like, some or all of which may be maintained in production logs. Further, the user feedback stored and maintained in the user feedback data store 140 may be used to generate embeddings and/or context aware updated embeddings by the one or more trained machine learning models employed by online service 125.

The computers, servers, data stores, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like.

In accordance with the disclosed implementations, the distributed training system 102 is configured to generate a recommendation policy for use in a production environment by the recommendation system 103 in which the recommendation policy is directed toward selecting items that improve session duration/depth (e.g., the number of items presented to a user during a session before the user ends the session). Accordingly, for MDP, M=(S, [symbol] , P, R, γ), where S represents the state space, [symbol] is the action space, P: S× [symbol] ×S→ [symbol] specifies the transition probability, R: S× [symbol] → [symbol] is the reward function, and γ∈[0,1] is a discount factor. At each step through an episode (a simulated user episode), the agent model of the distributed training system 102 observes a state s and selection of an action a following a policy π: S→ [symbol] . The environment then transitions to a new state s′ with probability P(s, a, s′) and returns an immediate reward R(s, a). The agent model's goal is to learn a policy such that the value function V^{π}(s₀):=Σₜ₌₀^{∞}γ^{t}Rₜ is maximized.

Each episode may involve a fixed user and terminate either when the simulated feedback is an exit or when the length of the episode has reached L. As discussed, the goal is to obtain a recommendation policy that is directed toward increasing long-term user satisfaction.

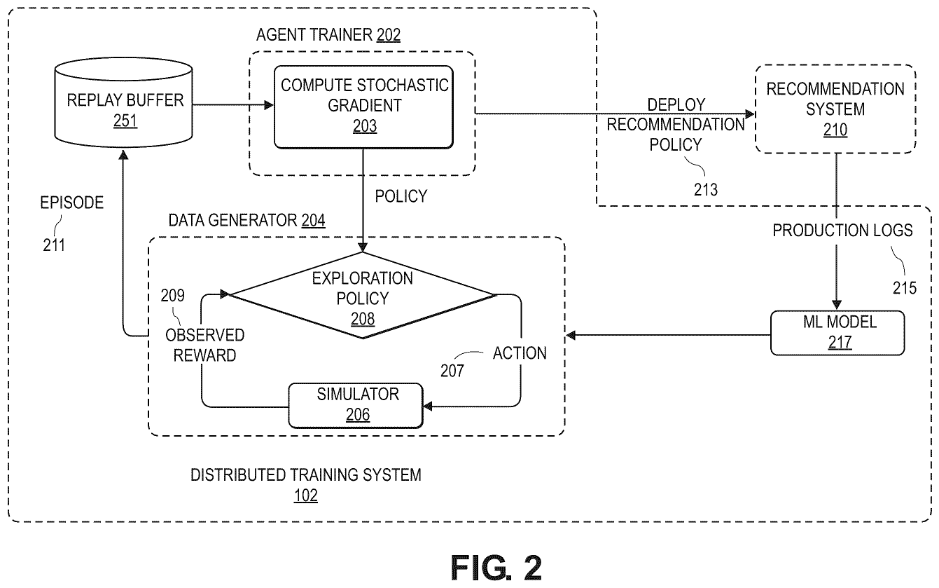

FIG. 2 is a block diagram illustrating additional details of the example distributed training system 102 illustrated in FIG. 1B, in accordance with implementations of the present disclosure.

The data generator 204, which includes a simulator 206, generates simulated episodes 211 of real-world users following an exploration policy 208. Each step of a simulated episode 211 includes a user state, an action 207 (selected content item), an observed reward 209 (reward value representative of a simulated feedback of the user in response to the item), and a next user state. A sequence of steps of a simulated episode are generated in succession as part of the simulated episode until the simulated feedback is an exit, which may be represented as a negative reward value. The episode 211 is then provided to and stored in a replay buffer 251. In some implementations, rather than the full simulated episode 211 being stored in the replay buffer after the simulated episode is complete, at the completion of each step of the simulated episode, that episode step, including the user state, action, reward, and next user state, may be sent to and stored in the replay buffer 251 as part of the simulated episode.

The agent trainer 202 obtains batches of simulated episode(s) 211 or episode steps of the simulated episodes from the replay buffer 251 and uses the simulated episode(s)/episode steps to compute a stochastic gradient that is used to update the policy. For example, the agent trainer 202 may update the policy by retrieving one or more simulated steps of one or more episode(s) from the replay buffer and utilizing those one or more simulated steps to perform gradient-based optimization, as discussed herein, to update the policy.

In some implementations, the policy used by the data generator 204, also referred to herein as an exploration policy, may be different than the agent trainer's 202 currently learned or updated policy. However, during training, the exploration policy used by the data generator 204 may be periodically updated to match the agent trainer's 202 currently learned policy. Likewise, each time convergence of training is achieved, the trained policy is deployed to the recommendation system 210 of a production environment as a recommendation policy 213 for use by the recommendation system 210 when recommending items to users. Within the production environment, the distributed training system 102 is not utilized or accessed by the recommendation system 210. Instead, the recommendation system 210 relies on the received recommendation policy 213 to recommend a next item to a user in the production environment. Likewise, once deployed, production logs 215 generated from the recommendation system 210 within the production environment, which may include records of presented content, user feedbacks, etc., will reflect the behavior of the deployed recommendation policy. Those production logs 215 may be sent back to the distributed training system 102, and used to refine the machine learning (ML) model 217, such as a one-step greedy model, that is used by the simulator 206 to simulate rewards in response to actions (selected candidate item). The simulator 206, in turn, generates updated simulated feedback and corresponding representative reward values for additional simulated episodes 211. Those additional simulated episodes 211 are then used by the agent trainer 202 to compute updated stochastic gradients and produce an updated policy. The updated policy is then provided back to the data generator 204 as an updated exploration policy 208 and, at convergence, deployed to the production recommendation system as an updated recommendation policy 213. This cycle may continue, receiving real-world production log feedback, updating the ML model 217 used by the simulator to generate updated simulated episodes, updating the policy by the agent trainer 202 based on the updated simulated episodes, and deploying the updated policy as an updated exploration policy and/or updated recommendation policy.

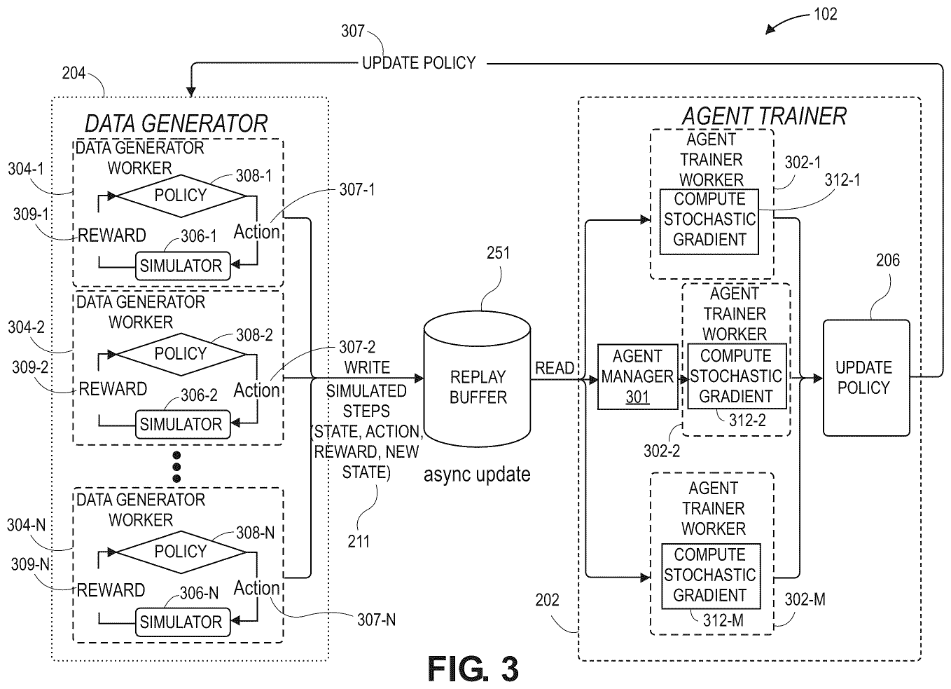

In some implementations, a distributed training process may be adopted that utilizes asynchronous operations to decouple data generation from policy optimization, as illustrated in FIG. 3. Such a distributed training process facilitates a learning speed production-scale recommendation service.

FIG. 3 is a block diagram illustrating additional example components of the distributed training system 102 of FIG. 1, in accordance with implementations of the present disclosure.

As illustrated, in the distributed training system 102, the data generator 204 and the agent trainer 202 are interconnected by the replay buffer 251. In the illustrated example, each of the data generator 204 and the agent trainer 202 generate multiple respective workers that may perform the functions of the data generator 204 and agent trainer 202 in parallel and asynchronously. For example, the data generator 204 may generate any number of data generator workers 304-1, 304-2, through 304-N. Each of the data generator workers 304-1 through 304-N, obtain a snapshot of the exploration policy 308-1, 308-2, through 308-N from the most recent updated policy 307 provided by the agent trainer 202 and use that exploration policy to generate actions (candidate items) and to simulate feedback to those actions with a simulator 306-1, 306-2, through 306-N. Each of the data generator workers 304-1 through 304-N may operate asynchronously of other data generator workers and in a manner similar to that described above, generating actions based on the policy and simulating feedback with the simulator 306-1-306-N. Those simulated steps 211, as they are generated by the different data generator workers 304-1-304-N may be written to the replay buffer 251. Alternatively, each step of an episode may be maintained by each respective data generator worker until the episode is complete and then the entire episode, including the steps written to the replay buffer 251.

The agent trainer 202 may include an agent manager 301 that coordinates actions of each of the agent trainer workers 302-1, 302-2, through 302-M so that the agent trainer workers remain synchronized. For example, the agent manager 301 reads one or more batches of episode steps, or one more batches of episodes from the replay buffer 251 and assigns each agent trainer worker 302-1 through 302-M one or more of the simulated episode steps or one or more of the simulated episodes. Each agent trainer worker, in response to receipt of one or more simulated episode steps/episodes, computes a stochastic gradient 312-1, 312-2, through 312-M in synchronous parallel. The agent manager then aggregates each of the stochastic gradients generated by the agent trainer workers and updates the recommendation policy 206, as discussed further below, based at least in part on the aggregate of the stochastic gradients.

The distributed architecture illustrated and discussed with respect to FIG. 3 provides a further improvement to the disclosed implementations by making use of asynchronous workers and the decoupling of data generation by the data generator 204 and the training process by the agent trainer 202. Specifically, data generator workers 304-1 through 304-N continue operating, generating simulated steps of simulated episodes without waiting for training steps to occur by the agent trainer 202. That is, the data generator workers 304-1 through 304-N are not idle while waiting for the agent trainer 202 to perform the training steps. Likewise, training by the agent trainer 202 proceeds independent of the data generator workers because the agent trainer 202 does not have to wait for simulated steps of episodes to be generated and provided by the data generator workers 304-1 through 304-N of the data generator 204.

As noted above, in large scale production systems, such as a web-based recommendation system that may include millions or billions of content items, a difficulty exists in exploration because the vast majority of the content items would not be recommended and/or of interest to a user in response to a query or otherwise. To resolve this shortcoming, the disclosed implements utilize an ML model, such as a one-step greedy model to simulate user feedback in response to items. The simulated feedback is used to update the state S with the most recent recommended items and the corresponding simulated feedback. Formally, if sₜ is the current state at time step t, at is the action taken (candidate item). Based on the action (candidate item) at the current step, and other information, such as the user state, the ML model, such as a greedy model, generates the predicted feedback [symbol] ₜ and the next state can be formed as sₜ₊₁=sₜ∪{aₜ, [symbol] ₜ}. The update mechanism ensure that the state consistently reflects the latest simulated interactions.

The predicted feedback is also used to infer rewards through, for example, a weighted sum of all feedback predictions. In one example, the reward function may be a defined as:

$${r}_{t} := {\sum }_{i = 1}^{i = \vert ℱ \vert} {c}_{i} \cdot ℙ ( {f}_{i} = {ℱ}_{i} \vert {s}_{t} , {a}_{t} ) , \qquad ( 2 )$$

where cᵢ represents a weight associated with the feedback type fᵢ, and [symbol] (fᵢ= [symbol] ᵢ|sₜ, aₜ) is the probability of feedback fᵢ given the state sₜ and action aᵢ, and [symbol] is the full set containing all possible feedback actions. Such a dense reward improves the stability of learning. As discussed herein, these probabilities may be produced by the simulator of the data generator/data generator workers.

Another advantage of using existing ML models, such as existing one-step greedy recommendation models, is the ability to bootstrap the disclosed implementations with pre-trained supervised models. For example, the disclosed implementations may utilize an existing recommendation model architecture, keeping some or all of the layers the same except for the output nodes. This pre-training boosts sample efficiency and ensures a more stable convergence compared with learning from scratch. One of the differences between existing models and the disclosed implementations is that the disclosed implementations predict cumulative rewards over T steps, rather than immediate rewards. For example, a Q-network that generates actions of the disclosed implementations can be expressed as:

$$Q ( s , a ) = \sum [ {\sum }_{t = 0}^{T} {γ}^{t} {r}_{t} \vert ( {s}_{0} , {a}_{0} ) = ( s , a ) ] . \qquad ( 3 )$$

The Q-network can be trained through Bellman optimality equation and its training objective may be to minimize the Temporal Difference (“TD”) error:

$$L ( θ ) = {𝔼}_{s , a , r , {s}^{′}} [ {( r + γ {max}_{{a}^{′}} Q ( {s}^{′} , {a}^{′} ; θ ) - Q ( s , a ; θ ) )}^{2} ] , \qquad ( 4 )$$

where θ represents the network parameters.

As is known, large-scale recommendation systems utilize traditional exploration strategies such as ε-greedy and SoftMax®. However, as is also known, such strategies, as utilized, lack sample efficiency since the action space (the corpus of content items) is massive, having millions or billions of content items.

The disclosed implementations overcome these limitations by utilizing a hybrid exploration strategy that combines elements from both ε-greedy and SoftMax®, enabling more effective exploration. As discussed further herein, the implementations enhance sample efficiency and scalability, enabling recommendations of items designed to increase long-term user satisfaction in a web-scale environment.

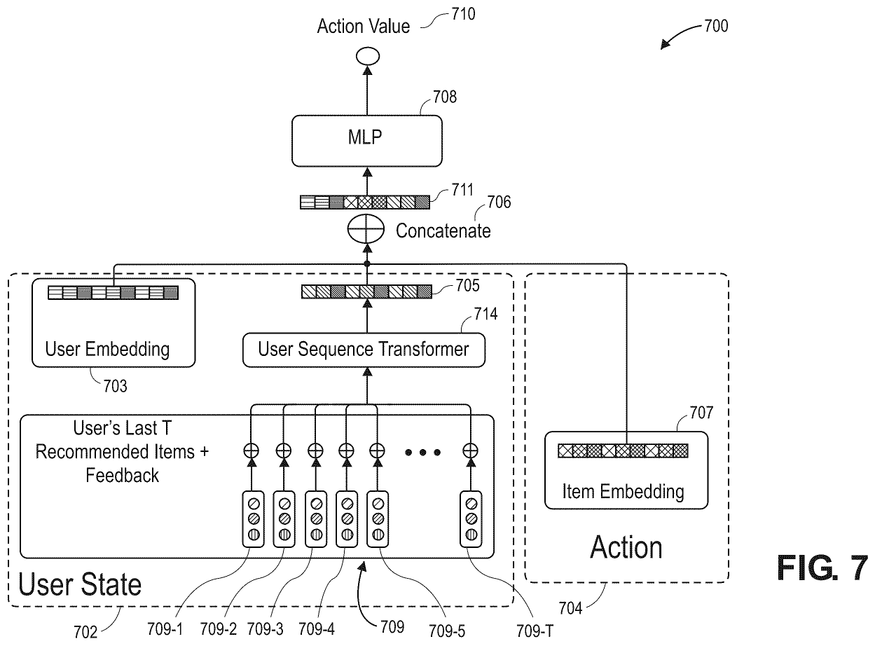

As discussed herein, the disclosed implementations take in both state and action features as inputs and outputs the long term value estimate of that action. This evaluation may be done for a plurality of actions, which resolves the shortcomings of traditional systems that fail to generalize across a large number of items (e.g., millions or billions of items) because those traditional systems do not utilize action features. This aspect of the disclosed implementations is discussed further below with respect to FIG. 7.

As discussed herein, a goal of the disclosed implementations is to improve a policy defined as:

$$π : S \to 𝒜 , \qquad ( 5 )$$

Where the policy π evaluates the current state sₜ and considers the available actions [symbol] , selecting the action that yields the highest Q-value, also referred to herein as an action value:

$$π ( {s}_{t} ) = {arg max}_{a ∈ 𝒜} Q ( {s}_{t} , a ) . \qquad ( 6 )$$

To efficiently train the Q-network, the TD error is minimized, as discussed above. This training technique allows the network to learn to predict long-term value of different recommendations, as discussed herein.

To overcome the challenge of exploring a large action space, such as a web-scale environment, rather than sampling uniformly over all content items, as is done with ε-greedy strategies, the disclosed implementations may constrain exploration to a set of content items with top-K Q-values (action values) of content items in the corpus. For example:

$${a}_{t} ∼ \{ \begin{matrix}{arg max}_{a ∈ 𝒜} Q ( {s}_{t} , a ) & with prob , 1 - ε \\ \frac{exp ( {Q}_{t} ( {s}_{t} , a ) )}{{\sum }_{{a}^{′} ∈ {𝒜}_{{Q}_{t}}^{K}} exp ( {Q}_{t} ( {s}_{t} , {a}^{′} ) )} \cdot 𝕝 \{ a ∈ {𝒜}_{{Q}_{t}}^{K} ( {s}_{t} ) \} & with prob . ε\end{matrix} \qquad ( 7 )$$

where [symbol] is the indicator function and [symbol] stands for the set of content items with top-K Q-values at time step t. The values K and ε may be customizable and the values of K and ε determine the extent of exploration. Larger values can increase convergence instability, whereas smaller values may limit the quality of the policy by limiting exploration. In some implementations, adaptive tuning may be utilized such that the values of K and ε may be decreased as training progresses. In the example illustrated above, with probability 1-ε the action with the highest Q-value is explored. With probability ε sampling from the top-K actions (ranked by Q-value) are explored using a softmax distribution. Accordingly, the above described hybrid exploration strategy enables exploration that is focused on the most promising content items, thereby increasing training stability. By truncating to the top-K actions, the exploration focuses on the most promising candidates, mitigating the inefficiency of random exploration in a vast space, such as a web-scale environment. At the same time, softmax sampling within the truncated set ensures that exploration remains probabilistic and thus sufficiently diverse, while still preferring actions with higher estimated Q-values, leading to faster convergence.

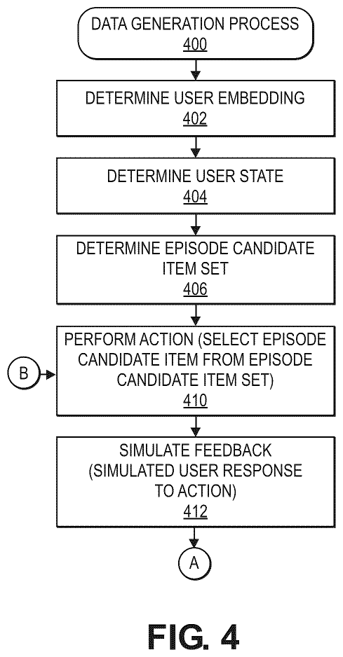

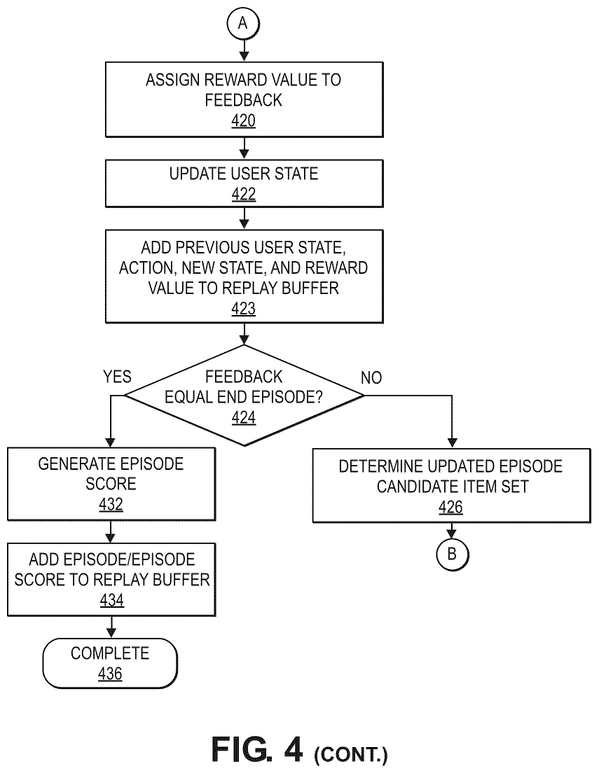

FIG. 4 is an example data generation process 400, in accordance with implementations of the present disclosure. The example process 400 is discussed with respect to a data generator generating data (simulated episodes) that may be used by an agent trainer to update a policy that may then be deployed to a recommendation system in a production environment as a recommendation policy and/or as an exploration policy for use by the data generator. With the recommendation policy, the recommendation system selects content items that increase long-term user satisfaction. Similarly, with the exploration policy, the data generator performs actions (selection of content items).

The example process 400 begins by determining or selecting a user embedding, as in 402. As discussed, a user embedding may include information about a user, such as user preferences, user past interactions, user past responses to items, etc. During simulation, a user embedding may be selected at random, generated based on previous users, synthetically generated based on one or more other existing user embeddings, etc.

In addition to determining or obtaining a user embedding, a user state of the user in the current simulated episode is determined, as in 404. The user state may include, for example, an indication of all actions (selected item(s)) generated during the episode, all feedback and corresponding reward values simulated as user responses to the actions, device type of the device currently simulated as in use during the simulated episode, etc. As will be appreciated, any of a variety of information relating to the simulation episode may be included in the user state.

Based on the user embedding and the user state, an episode candidate item set may be generated that includes one or more candidate items that may be presented, as in 406. In some implementations, the one or more candidate items may be determined by an ML system using, for example, a greedy algorithm and a current exploration policy to determine the items most likely to be of interest to the user as a next item, based on the user state and the user embedding. In other implementations, other recommendation systems or techniques may be used to determine the one or more candidate items included in the episode candidate item set.

An action (selecting an item) from the episode candidate item set may then be performed, as in 410. The action may include randomly selecting a candidate item from the candidate item set, selecting a highest ranked candidate item from the candidate item set, as ranked by the ML model, or based on any other criteria for selecting a candidate item as the first item to be presented in the episode.

The simulator may then simulate the most likely or predicted feedback to be performed in response to the action (selected candidate item), as in 412. The predicated feedback is determined based on the episode user state of the user in the episode and the action (candidate item). As discussed, the simulator may be a machine learning or other artificial intelligence model that is trained to predict a user feedback in response to an item, based on, for example, the user state and the action.

A reward value may then be assigned to the predicted feedback, as in 420. For example, different possible predicted feedback may receive different reward values based on the desired feedback. In some implementations, the reward values may be linear in that the reward value of each potential feedback has a linear increase or decrease in value with respect to other feedback. In other implementations, the reward value assigned to different feedback may be weighted or otherwise vary in value/importance when compared to the reward values associated with other feedback.

The user state for the episode may then be updated to consider both the item and the predicated feedback, as if the item had been presented and the feedback had been performed, as in 422. In some implementations, the step corresponding to the episode, which includes the starting user state when the step began, the action, the reward value, and the new user state may be stored in the replay buffer, as in 423. As noted above, in some implementations, the information for each step of an episode may be stored in the replay buffer as each step is completed, as illustrated by block 423. In other implementations, the example process 400 may maintain all information until the episode is complete and at that point, the entire episode, including each step of the episode and corresponding information may be added to the replay buffer.

A determination may then be made as to whether the predicted feedback equals an end episode (e.g., exit), as in 424, or other available action that results in a termination of the episode.

If it is determined that the predicated feedback is an end episode, an episode score is generated and assigned to the episode, as in 432. In some implementations, the episode score may be a sum of reward values generated for the different feedback predicted for the episode, a sum of the number of actions predicted to be performed during the episode prior to the end episode, a combination of both the reward values and the number of predicted actions, etc. The episode/episode score may then be added to the replay buffer, as in 434. For example, if steps of the episode are not added to the replay buffer at block 423, the episode (including each step of the episode) and episode score may be added to the replay buffer at block 432. Alternatively, if the steps of the episode have been added to the replay buffer at block 423, the episode score may be added to the replay buffer at block 434. Finally, the example process 400 completes, as in 436.

Returning to decision block 424, if it is determined that the feedback is not an end episode, a new set of episode candidate items is determined, as in 426. For example, a new set of episode candidate items may be determined based on the user embedding and the user state, which, at block 422, has been updated to include the previously action and predicted reward value for the predicted feedback. The example process 400 then returns to block 410 and generates a next action (selects next candidate item) based on the updated candidate item set.

In some implementations, the simulator 104 may be initialized based on a trained predictive model, such as a multi-head model to predict the likelihood of user feedback. In such a model, the predictions are based on both the current user context, the recommended items (actions), and user history of the user (e.g., past user responses). The feedback determined by the simulator may then be determined, for example, as a weighted sum of predicted probabilities, as illustrated in equation (2) above. To generate a next state, the feedback with the highest predicted probability may be selected and used as the simulated feedback fₜ.

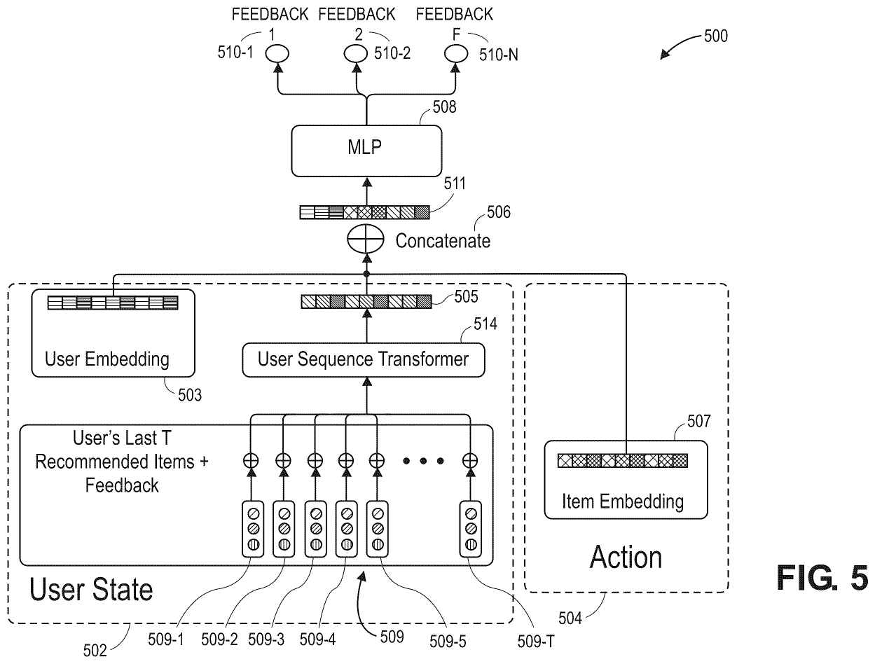

FIG. 5 is an example illustration of a simulation architecture 500, in accordance with disclosed implementations.

The user state 502, as discussed herein, may be illustrated as a user embedding 503 that semantically represents the user and a user sequence embedding 505 that semantically represents the last T recommended items presented and corresponding user feedback, represented as reward values. The user embedding 503 may indicate information about the user, such as user preferences, user item views, user location, user persona, device type, etc. The user sequence embedding 505 may be generated as an output from a user sequence transformer 514 that receives, as it inputs, the last T recommended items plus the corresponding feedback 509; each pair of recommended items and corresponding feedback indicated as 509-1, 509-2, 509-3, 509-4, 509-5 through 509-T. In some implementations, each recommended item and corresponding feedback may also include a time at which the item was presented, a time at which the feedback was performed, a location of the user when the item was shown, a device type used by the user to view the item, and/or other information. The action 504 is represented by an item embedding 507 that semantically represents an item selected for the action, such as a video, a photo, etc.

The user embedding 503, user sequence embedding 505, and the item embedding 507 may be concatenated 506 to form a concatenated embedding 511 that is composed of the user embedding 503, user sequence embedding 505, and the action embedding 507. The concatenated embedding 511 may then be processed by a feedforward artificial neural network, such as a multilayer perceptron (“MLP”) that predicts the probability, based on the concatenated embedding 511, of different predicted feedback 510-1, 510-2, through 510-N occurring. Different predicted feedback for which probabilities may be determined include, but are not limited to, view, share, save, hide, exit, etc.

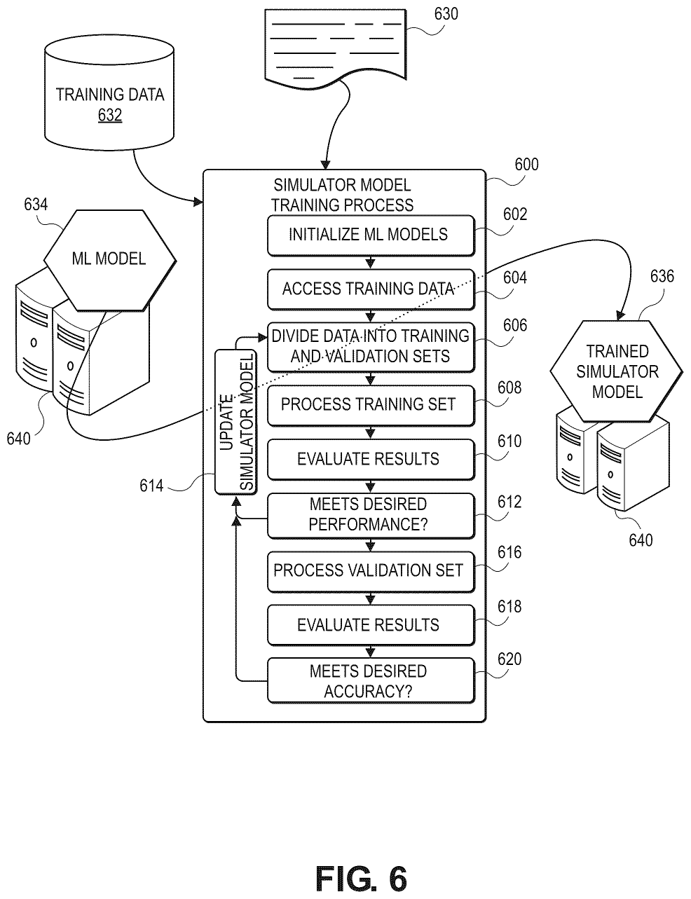

FIG. 6 is a flow diagram of an exemplary training process 600 for training a machine learning model, such as the simulator model discussed herein, according to exemplary implementations of the present disclosure.

As shown in FIG. 6, training process 600 is configured to train a machine learning (ML) model 634 (e.g., such as a deep neural network, etc.) operating on computer system 640 to transform the ML model 634 into trained ML model 636 that is trained to perform simulations as discussed herein. The trained ML model 636 may operate on the same or another computer system, such as remote computing resource 120. In the course of training, as shown in FIG. 6, at step 602, the ML model 634 is initialized with training criteria 630. Training criteria 630 may include, but is not limited to, information as to a type of training, number of layers to be trained, training objectives, etc.

At step 604 of training process 600, corpus of training data 632, may be accessed. For example, training data 632 may include one or more sequences of user feedback over a period of time. The sequence of user feedback can include, for example, representations of content items with which users have engaged and/or generated feedback in response thereto (e.g., partial watch, long watch, save, hide, or exit), over the period of time. Further, accessing training data 632 can also include accessing positive and negative labeled training data. For example, for a particular set of user feedback, a period in time may be selected, and user feedback occurring after the period in time can be labeled as positive training data. Further, negative labeled training data may include, for example, randomly sampled content items from a corpus of content items and/or content items associated with user feedback that were not positive engagements of a particular respective user.

With training data 632 accessed, at step 606, training data 632 is divided into training and validation sets. Generally speaking, the items of data in the training set are used to train the ML model 634 and the items of data in the validation set are used to validate the training of the ML model. As those skilled in the art will appreciate, and as described below in regard to much of the remainder of training process 600, there are numerous iterations of training and validation that occur during the training of the ML model.

At step 608 of training process 600, the data items of the training set are processed, often in an iterative manner. Processing the data items of the training set includes capturing the processed results. After processing the items of the training set, at step 610, the aggregated results of processing the training set are evaluated, and at step 612, a determination is made as to whether a desired performance has been achieved. A desired performance may be achieved, for example, when evaluation of the ML model reaches a desired accuracy when compared with the labels of the training data. If the desired performance is not achieved, in step 614, aspects (e.g., weighting values) of the machine learning model are updated to guide the machine learning model to achieve the desired performance. After updating aspects of the ML model, processing returns to step 606, where a new set of training data is selected, and the process repeats. Alternatively, if the desired performance is achieved, training process 600 advances to step 616.

At step 616, and much like step 608, the data items of the validation set are processed, and at step 618, the processing performance of this validation set is aggregated and evaluated. At step 620, a determination is made as to whether a desired performance, in processing the validation set, has been achieved. If the desired performance is not achieved, in step 614, aspects of the machine learning model are updated to guide the machine learning model to achieve the desired performance. After updating aspects of the ML model, the training process 600 returns to step 606. Alternatively, if the desired performance is achieved, the ML model is considered to be trained ML model 636 and may be used with the disclosed implementations to perform simulations as part of data generation. Also, as discussed herein, the trained ML model may be periodically updated. In some implementations, for agent training, the policy or value function used by the agent may be warmed up with product recommendations. For example, a teacher-student paradigm may be adopted to train the policy network (as the student) such that the policy network initially mimics the existing recommender (teacher) with supervised learning. As another example, the policy network may be warmed up by fitting over transition samples obtained from use of an existing recommendation engine in the simulator environment.

FIG. 7 is an example illustration of architecture 700, also referred to herein as a Q-network that may be utilized in item selection (action) that optimizes for long-term user satisfaction, in accordance with implementations of the present disclosure.

The user state 702, as discussed herein, may be illustrated as a user embedding 703 that semantically represents the user and a user sequence embedding 705 that semantically represents the last T recommended items presented to the user and corresponding user feedback, represented as reward values. The user embedding 703 may indicate information about the user, such as user preferences, user item views, user location, user persona, device type, etc. The user sequence embedding 705 may be generated as an output from a user sequence transformer 714 that receives, as it inputs, user's last T recommended items plus the corresponding feedback 709; each pair of recommended items and corresponding feedback indicated as 709-1, 709-2, 709-3, 709-4, 709-5 through 709-T. In some implementations, each recommended item and corresponding feedback may also include a time at which the item was shown, a time at which the feedback was performed, a location of the user when the item was shown, a device type used by the user to view the item, and/or other information. The action 704 is represented by an item embedding 707 that semantically represents an item selected for the action, such as a video, a photo, etc., that may be presented to the user.

The user embedding 703, user sequence embedding 705, and the item embedding 707 may be concatenated 706 to form a concatenated embedding 711 that is composed of the user embedding 703, user sequence embedding 705 and the item embedding 707. The concatenated embedding 711 may then be processed by a feedforward artificial neural network, such as an MLP, that predicts, according to the exploration policy, the action user value 710 for the action of presenting the item represented by the item embedding 707 to the user.

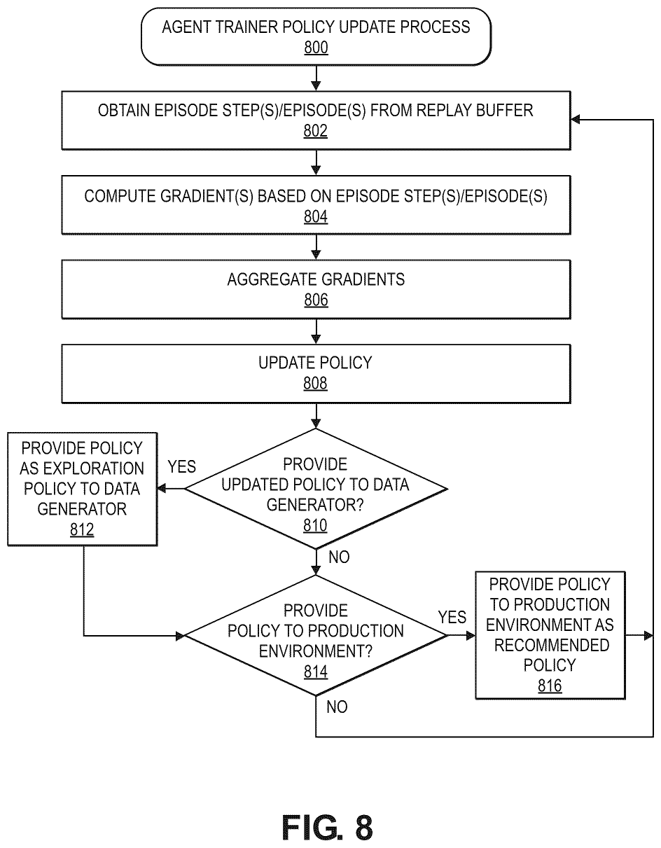

FIG. 8 is a flow diagram of an exemplary agent trainer policy update process 800, in accordance with implementations of the present disclosure. As discussed above, the example process 800 may be performed by the agent trainer, which includes an agent manager 301 and one or more agent trainer workers 302-1 through 302-M.

The example process 800 begins by obtaining one or more episode steps or one or more episodes from a replay buffer, as in 802. As discussed above, a data generator 204 may, independent of the agent trainer, generate training data, also referred to herein as episode steps/episodes that may be obtained by the agent trainer as part of the example process 800.

One or more stochastic gradient(s) may then be computed based on the retrieved episode steps/episodes, as in 804. For example, and as discussed above, the agent manager may provide episode steps/episodes to different agent trainer workers and instruct each agent trainer worker, operating in synchronous parallel, to compute a gradient of the TD error based on the provided episode steps/episodes.

Each of the computed gradients are then aggregated, for example by the agent manager, as in 806, and used to update the policy (the model parameters represented in the policy), as in 808. A determination may then be made as to whether the policy is to be provided to the data generator for use by the data generator as an exploration policy, as in 810. In some implementations, the policy may be provided to the data generator as an exploration policy after each update to ensure that the data generator is using an up-to-date policy for generating actions (selecting candidate items). In other implementations, the policy may be provided to the data generator at other intervals (e.g., hourly). If it is determined that the policy is to be provided to the data generator, the policy may be published or sent to the data generator as an exploration policy, as in 812.

If it is determined that the policy is not to be provided to the data generator at decision block 810, or after providing the policy to the data generator at block 812, it may be determined if the policy is to be published or provided to a recommendation system operating in a production environment for use as a recommendation policy, as in 814. In some implementations, the policy may be provided to the recommendation system in the production environment with each update. In other implementations, the policy may be provided to the recommendation system in the production environment as a recommendation policy at convergence. As is known, convergence may be considered to occur when training produces little to no improvement in performance or change in loss function value or temporal difference error, when performance metrics stabilize (e.g., the learning curve flattens out), there are minimal parameter updates with additional training, when the gradient of the error approaches zero, after a fixed number of iterations or epochs, etc.

If it is determined that the policy is to be provided to a recommendation system operating in a production environment, the policy may be published or sent to the recommendation system in the production environment as a recommendation policy for use by the recommendation system when selecting items to recommend to a user, as in 816.

After providing the policy to the recommendation system at block 816, or if it is determined at decision block 814 that the policy is not to be provided to a recommendation system in a production environment, the example process 800 returns to block 802 and continues.

FIG. 9 is a block diagram conceptually illustrating example components of a remote computing device, such as computing resource 900 (e.g., computing resources 120, etc.) that may be used with the described implementations, according to exemplary implementations of the present disclosure.

Multiple such computing resources 900 may be included in the system. In operation, each of these devices (or groups of devices) may include computer-readable and computer-executable instructions that reside on computing resource 900, as will be discussed further below.

Computing resource 900 may include one or more controllers/processors 904, that may each include a CPU for processing data and computer-readable instructions, and memory 905 for storing data and instructions. Memory 905 may individually include volatile RAM, non-volatile ROM, non-volatile MRAM, and/or other types of memory. Computing resource 900 may also include a data storage component 908 for storing data, user feedback, content items, etc. Each data storage component may individually include one or more non-volatile storage types such as magnetic storage, optical storage, solid-state storage, etc. Computing resource 900 may also be connected to removable or external non-volatile memory and/or storage (such as a removable memory card, memory key drive, networked storage, etc.) through input/output device interfaces 932.

Computer instructions for operating computing resource 900 and its various components may be executed by the controller(s)/processor(s) 904, using memory 905 as temporary “working” storage at runtime. The computer instructions may be stored in a non-transitory manner in non-volatile memory 905, storage 908, or an external device(s). Alternatively, some or all of the executable instructions may be embedded in hardware or firmware on computing resource 900 in addition to or instead of software.

For example, memory 905 may store program instructions that when executed by the controller(s)/processor(s) 904 cause the controller(s)/processors 904 to process information with the data generator 906 and/or the agent trainer 907 to determine a next item to present or share with a user, for example, that optimizes for long-term user satisfaction (e.g., longer session/depth).

Computing resource 900 also includes input/output device interface 932. A variety of components may be connected through input/output device interface 932. Additionally, computing resource 900 may include address/data bus 924 for conveying data among components of computing resource 900. Each component within computing resource 900 may also be directly connected to other components in addition to (or instead of) being connected to other components across bus 924.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk and/or other media. In addition, components of one or more of the modules and engines may be implemented in firmware or hardware.

Moreover, with respect to the one or more methods or processes of the present disclosure shown or described herein, including but not limited to the flow charts shown in FIGS. 4, 6, and 8, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

The elements of a method, process, or algorithm described in connection with the implementations disclosed herein can also be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
for each step of a plurality of steps of a simulated episode:
determining a user state;
generating, based at least in part on the user state, an action that includes a selection of a candidate item;
simulating a feedback in response to the candidate item, wherein the feedback is selected from a plurality of feedback that may be provided by a user in response to a presentation of an item;
assigning a reward value to the feedback, the reward value corresponding to a value of the feedback with respect to other feedback of the plurality of feedback;
advancing the user state to a next user state as if the user had been presented the candidate item and provided the feedback; and
generating an episode step that includes, at least, the user state, the action, the reward value, and the next user state;
computing, based at least in part on a plurality of the episode steps, a gradient of a temporal difference error of a policy, wherein the policy is directed toward extending a duration of a user episode;
updating, based at least in part on the gradient, the policy;
providing the policy to a recommendation system as a recommendation policy for use by the recommendation system to recommend an item to a user; and
providing, with the recommendation system and based at least in part on the policy, a recommended item to a user.

2. The computer-implemented method of claim 1, wherein the feedback is at least one of a partial watch, a long watch, a save, a hide, a share, or an exit.

3. The computer-implemented method of claim 1, further comprising:
determining that the feedback is an exit; and
in response to determining that the feedback is an exit:
ending the simulated episode;
computing, based at least in part on one or more of the reward values or a number of actions, an episode value; and
storing at least one of the episode or the episode value in a replay buffer.

4. The computer-implemented method of claim 1, further comprising:
storing the episode step in a replay buffer; and
obtaining, from the episode step, the plurality of episode steps.

5. The computer-implemented method of claim 1, wherein generating the action, simulating the feedback, and assigning the reward are performed independent of and in parallel with computing the gradient.

6. A system, comprising:
a data generator, including:
an action agent that utilizes an exploration policy to generate an action of selecting a candidate item;
a simulator configured to simulate a feedback in response to the action;
the data generator configured to at least:
generate a plurality of episode steps, each episode step including, at least:
a current user state of a user;
an action generated by the action agent based at least in part on the exploration policy and a user model, wherein the action includes at least a selection of a candidate item of a plurality of candidate items;
a feedback in response to the action, the feedback indicative of a feedback of a plurality of feedback that may be provided by a user in response to the action; and
a next user state as if the user had been presented with the candidate item of the action and provided the feedback; and
an agent trainer configured to at least:
obtain a plurality of episode steps generated by the data generator; and
update a policy based at least in part on the plurality of episode steps.

7. The system of claim 6, wherein the agent trainer is further configured to at least:
publish the policy as a recommendation policy to a recommendation system operating in a production environment.

8. The system of claim 6, wherein the agent trainer is further configured to at least:
publish the policy as the exploration policy to the data generator for use by the data generator to generate actions.

9. The system of claim 6, wherein the agent trainer configured to update the policy, is further configured to at least:
compute, based at least in part on the plurality of episode steps, a gradient of a temporal difference error of the policy; and
based at least in part on the gradient, update the policy.

10. The system of claim 6, wherein the agent trainer further includes:
a plurality of agent trainer workers, each agent trainer worker configured to compute a gradient of a temporal difference error based on a plurality of episode steps; and
an agent manager configured to at least:
obtain at least some of the plurality of episode steps;
provide episode steps of the at least some of the plurality of episode steps to each of the plurality of agent trainer workers;
aggregate the gradient computed by each of the plurality of agent trainer workers to produce an aggregated gradient; and
update the policy based at least in part on the aggregated gradient.

11. The system of claim 10, wherein the agent manager is further configured to a least:
cause each of the agent trainer workers to compute the gradient synchronously and in parallel.

12. The system of claim 6, wherein the candidate item is at least one of a video, an audio, or an image.

13. The system of claim 6, wherein the feedback is at least one of a partial watch, a long watch, a save, a hide, a share, or an exit.

14. The system of claim 6, wherein:
the data generator is further configured to, at least, store each episode step in a replay buffer independent of the agent trainer; and
the agent trainer is further configured to, at least, obtain, from the replay buffer and independent of the data generator, the plurality of episode steps.

15. The system of claim 6, wherein the simulator utilizes a greedy machine learning model to simulate the feedback in response to the action.

16. A computer-implemented method to generate a policy for a recommendation system, comprising:
generating, with a data generator, a plurality of episode steps that include an action and a feedback, wherein the action includes a candidate item and the feedback includes a simulated feedback of a user in response to the candidate item;
storing, in a replay buffer, the plurality of episode steps;
retrieving, from the replay buffer, independent of the data generator, and with an agent trainer, one or more of the plurality of episode steps;
updating, by the agent trainer and based at least in part on the one or more of the plurality of episode steps, the policy; and
publishing the policy to the recommendation system as a recommendation policy for use by the recommendation system to recommend items.

17. The computer-implemented method of claim 16, wherein updating the policy further includes:
computing, based at least in part on the one or more of the plurality of episode steps, a gradient of a temporal difference error of the policy; and
updating the policy based at least in part on the gradient.

18. The computer-implemented method of claim 16, further comprising:
selecting, with the data generator, a user embedding of a user; and
generating, based at least in part on the user embedding, the action.

19. The computer-implemented method of claim 16, wherein:
the data generator includes a plurality of data generator workers;
each of the plurality of data generator workers generate episode steps of the plurality of episode steps; and
each data generator worker of the plurality of data generator workers work independent of other data generator workers of the plurality of data generator workers.

20. The computer-implemented method of claim 16, wherein:
the agent trainer includes:
a plurality of agent trainer workers; and
an agent manager that coordinates actions of each of the plurality of agent trainer workers.
